(19) United States
(12) Patent Application Publication
(10) Pub. No.: US 2013/0243668 A1
(43) Pub. Date: Sep. 19, 2013

(54) LIQUID ANALYSIS CONTAINER

(71) Applicants: Fu-Chun Huang, Hsinchu (TW); Cheng-Chang Lai, Hsinchu (TW)

(72) Inventors: Fu-Chun Huang, Hsinchu (TW); Cheng-Chang Lai, Hsinchu (TW)

(73) Assignee: LITE-ON IT CORPORATION, TAIPEI CITY (TW)

(21) Appl. No.: 13/471,458

(22) Filed: May 15, 2012

(30) Foreign Application Priority Data
Mar. 16, 2012 (CN) 201210069772.1

(51) Int. Cl. B01L 3/00

(52) U.S. Cl. 422/547

(57) ABSTRACT

A liquid analysis container includes a main body and a barrier device. The main body has an accommodating space and a first opening. The barrier device is disposed on the main body and covers the first opening. An accommodating cavity is formed between the barrier device and the main body. The accommodating cavity is connected to the accommodating space through the first opening. The barrier device has a second opening. The accommodating cavity is connected to an external environment through the second opening. An opening diameter of the second opening is larger than an opening diameter of the first opening.

### CROSS-REFERENCE TO RELATED APPLICATION

This application claims the priority benefit of China application serial no. 201210069772.1, filed on Mar. 16, 2012. The entirety of the above-mentioned patent application is hereby incorporated by reference herein and made a part of this specification.

### BACKGROUND OF THE DISCLOSURE

1. Field of the Disclosure

The invention relates to a container, and more particularly, to a liquid analysis container.

2. Description of Related Art

In clinical examinations of blood components, various types of blood analysis apparatuses may be used to analyze the blood. One way to analyze the blood is to use a dropper and a dispenser to inject the blood into a liquid analysis container or directly drop the blood into the liquid analysis container and then place the liquid analysis container into a liquid analysis equipment to analyze the blood in the liquid analysis container. Parameters required may be obtained by analyzing the blood. For patients under complex medical treating procedures such as operations and patients under special care for serious diseases, to determine the parameters of these patients is especially important. The parameters provide medical staff with important information regarding statuses of the patients and allow the medical staff to provide proper and complete treatments to the patients.

In a process of injecting the blood into the liquid analysis container, the blood is easy to remain around an injection hole of the liquid analysis container or on other places outside of the liquid analysis container. The blood remaining on the liquid analysis container tends to cause pollution to the liquid analysis container, such as polluting a barcode of the liquid analysis container, which influences optical reading and recognition, causes an analytic accuracy to decrease, and makes regular cleaning and maintenance and changes of consumptive materials necessary for the analysis equipment. In addition, if the remaining blood is infective, the medical stuff will be under a danger of infection when contacting the remaining blood directly.

### SUMMARY OF THE DISCLOSURE

The invention provides a liquid analysis container which prevents an under-testing liquid from remaining on an outside of the liquid analysis container.

The invention provides a liquid analysis container including a main body and a barrier device. The main body includes an accommodating space and a first opening. The barrier device is disposed on the main body and covers the first opening. An accommodating cavity is formed between the barrier device and the main body. The accommodating cavity is connected to the accommodating space through the first opening. The barrier device has a second opening. The accommodating cavity is connected to an external environment through the second opening. An opening diameter of the second opening is larger than an opening diameter of the first opening.

In an embodiment of the invention, when a dropper is inserted into the accommodating space, there is a gap between the dropper and an inner edge of the second opening.

In an embodiment of the invention, the first opening is located in an orthographic projection of the second opening on the main body.

In an embodiment of the invention, an inner diameter of the accommodating cavity is larger than an opening diameter of the second opening.

In an embodiment of the invention, the main body has a third opening covered by the barrier device. The accommodating cavity is connected to the accommodating space through the third opening. The under-testing liquid in the accommodating cavity flows to the accommodating space through the third opening.

In an embodiment of the invention, the accommodating space is partitioned into a first subspace and a second subspace. The first subspace is connected to the accommodating cavity through the first opening. The main body further has a third opening covered by the barrier device. The second subspace is connected to the accommodating cavity through the third opening. The under-testing liquid in the accommodating cavity flows to the second subspace through the third opening.

In an embodiment of the invention, the main body further has a channel and a chamber. The chamber is connected to the accommodating space through the channel. The chamber is for containing an agent. The under-testing liquid is for flowing to the chamber through the channel.

In an embodiment of the invention, the barrier device includes an annular body and a cover. The annular body is disposed on the main body and surrounds the first opening. The cover covers the annular body, wherein the second opening is formed on the cover. The accommodating cavity is formed among the cover, the annular body, and the main body.

In an embodiment of the invention, a surface of the main body has a concave. The first opening is formed at a bottom of the concave, and the barrier device is embedded in the concave.

Based on the above, the barrier device of the invention covers the first opening of the main body, and the opening diameter of the second opening of the barrier device is larger than the opening diameter of the first opening of the main body. When a user uses the dropper to inject the under-testing liquid into the accommodating space through the second and the first openings, the under-testing liquid remaining around the first opening is limited within the accommodating cavity by the barrier device. In addition, the dropper is unlikely to contact the inner edge of the second opening with a larger opening diameter, so that the under-testing liquid does not remain around the second opening. In this way, the under-testing liquid is prevented from remaining on the outside of the liquid analysis container and polluting the analysis equipment, so that the accuracy of liquid analysis is ensured, and a probability that the user becomes infected owing to contacting the under-testing liquid is lowered.

In order to make the aforementioned features and advantages of the invention more comprehensible, embodiments accompanied with figures are described in detail below.

### BRIEF DESCRIPTION OF THE DRAWINGS

The accompanying drawings constituting a part of this specification are incorporated herein to provide a further understanding of the invention. Here, the drawings illustrate embodiments of the invention and, together with the description, serve to explain the principles of the invention.

FIG. 1 is a side view of a liquid analysis container according to an embodiment of the invention.

FIG. 2 is a partial three-dimensional view of the liquid analysis container of FIG. 1.

FIG. 3 is a schematic view of a dropper inserted into an accommodating space in FIG. 1.

FIG. 4 is a top view of the liquid analysis container of FIG. 2.

FIG. 5 is a partial three-dimensional view of a liquid analysis container according to another embodiment of the invention.

FIG. 6 is a partial three-dimensional view of a liquid analysis container according to another embodiment of the invention.

FIG. 7 is a partial cross-sectional view of a liquid analysis container according to another embodiment of the invention.

### DETAILED DESCRIPTION OF THE EMBODIMENTS

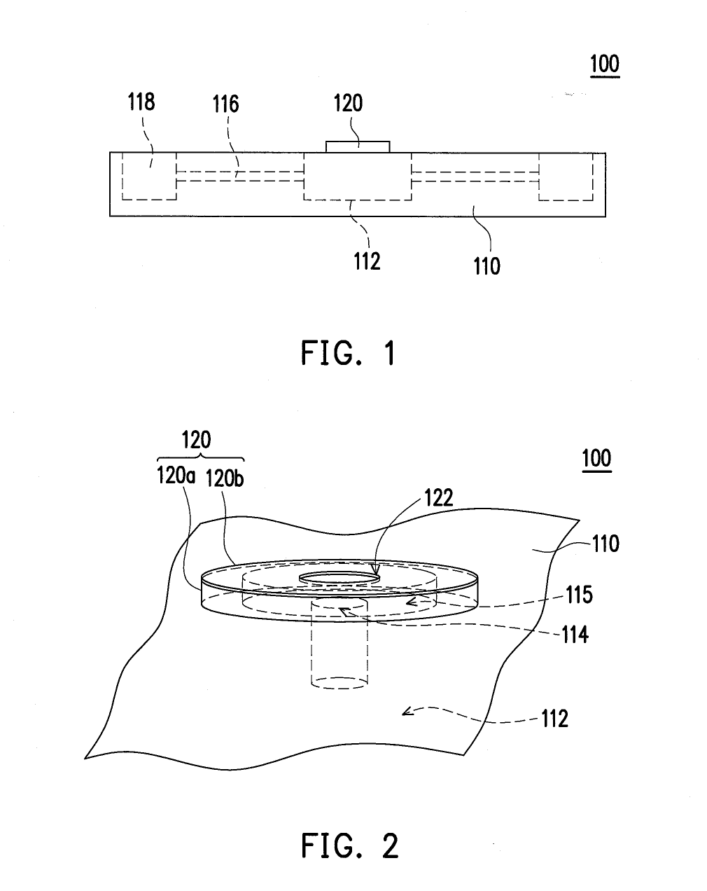

FIG. 1 is a side view of a liquid analysis container according to an embodiment of the invention. FIG. 2 is a partial three-dimensional view of the liquid analysis container of FIG. 1. Please refer to both FIGS. 1 and 2. A liquid analysis container 100 according to the present embodiment includes a main body 110 and a barrier device 120. The main body 110 includes an accommodating space 112 and a first opening 114. The barrier device 120 is disposed on the main body 110 and covers the first opening 114 of the main body 110. An accommodating cavity 115 is formed between the barrier device 120 and the main body 110, and the accommodating cavity 115 is connected to the accommodating space 112 through the first opening 114. The barrier device 120 has a second opening 122, and the accommodating cavity 115 is connected to an external environment through the second opening 122. As shown in FIG. 2, an opening diameter of the second opening 122 of the barrier device 120 is larger than an opening diameter of the first opening 114 of the main body 110.

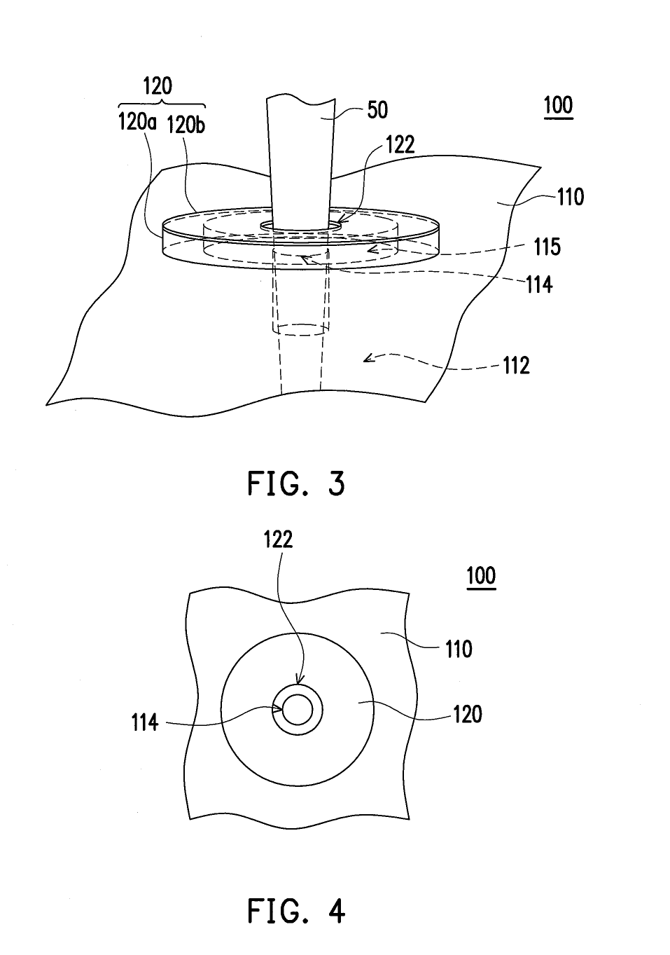

FIG. 3 is a schematic view of a dropper inserted into the accommodating space in FIG. 1. Please refer to FIG. 3. An user may insert a dropper 50 into the accommodating space 112 of the main body 110 through the second and the first openings 122 and 114 to inject an under-testing liquid into the accommodating space 112. When the user withdraws the dropper 50, the under-testing liquid is likely to remain around the first opening 114 of the main body 110, and the barrier device 120 covering the first opening 114 makes the under-testing liquid which remains around the first opening 114 to be isolated within the accommodating cavity 115. In addition, the second opening 122 of the barrier device 120 has a larger opening diameter; therefore, when the dropper 50 is inserted into the accommodating space 112, a gap is formed between the dropper 50 and an inner edge of the second opening 122 and the dropper 50 is unlikely to contact the inner edge of the second opening 122, so that the under-testing liquid does not remain around the second opening 122. In this way, the under-testing liquid is prevented from remaining on an outside of the liquid analysis container 100 and polluting an analysis equipment, so that an accuracy of liquid analysis is ensured, and a probability that the user becomes infected owing to contacting the under-testing liquid is lowered.

In the present embodiment, the liquid analysis container 100 is applied to a human blood analysis and test, for example. However, in other embodiments, the liquid analysis container 100 may also be applied to analyses and tests of other types of liquid samples, which is not limited in the invention.

Please refer to FIG. 1. The main body 110 of the present embodiment further has at least a channel 116 (a plurality of channels are shown) and at least a chamber 118 (a plurality of chambers are shown). The chamber 118 is connected to the accommodating space 112 through the channel 116, and the chamber 118 is for containing an agent for analysis. The under-testing liquid injected into the accommodating space 112 may flow to the chamber 118 through the channel 116 to mix with the agent so as to facilitate the analysis and test.

Please refer to FIG. 2. In detail, the barrier device 120 according to the present embodiment includes an annular body 120a and a cover 120b. The annular body 120a is disposed on the main body 110 and surrounds the first opening 114. The cover 120b covers the annular body 120a. The second opening 122 is formed on the cover 120b. The accommodating cavity 115 is formed among the cover 120b, the annular body 120a, and the main body 110. The cover 120b is fixed on the annular body 120a by, for example, adhering to the annular body 120a, but the invention is not limited thereto. The cover 120b and the annular body 120a may be an integrated structure manufactured simultaneously with injection molding.

In the present embodiment, an inner diameter of the accommodating cavity 115 is larger than the opening diameter of the second opening 122, so that the accommodating cavity 115 has adequate space for containing the remaining under-testing liquid to prevent the under-testing liquid from overflowing to an outside of the barrier device 120 through the second opening 122.

FIG. 4 is a top view of the liquid analysis container of FIG. 2. Please refer to FIG. 4. In the present embodiment, the first opening 114 of the main body 110 is located in an orthographic projection of the second opening 122 of the barrier device 120 on the main body 110. In this way, the dropper 50 may be inserted into the accommodating space 112 smoothly passing through the second and the first openings 122 and 114 sequentially, and the dropper 50 may be prevented from contacting the inner edge of the second opening 122.

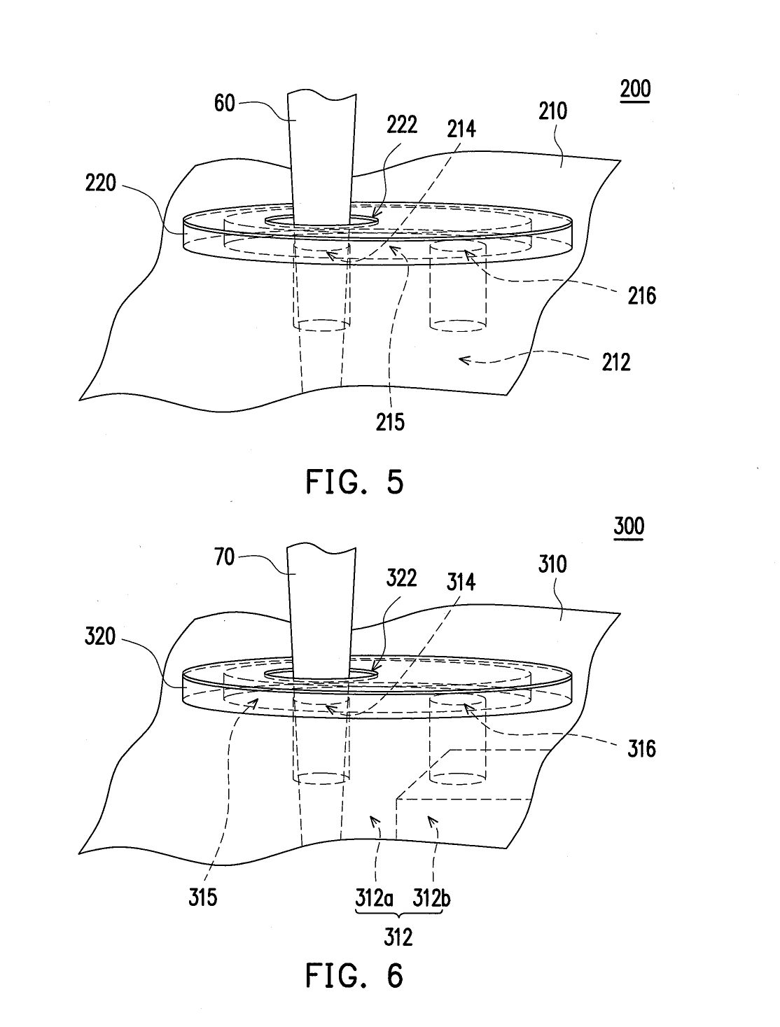

FIG. 5 is a partial three-dimensional view of a liquid analysis container according to another embodiment of the invention. Please refer to FIG. 5. In a liquid analysis container 200 of the present embodiment, designs of a first opening 214, a barrier device 220, and a second opening 222 are similar to designs of the first opening 114, the barrier device 120, and the second opening 122. Therefore, the descriptions are not repeated herein. Differences between the liquid analysis container 200 of the present embodiment and the liquid analysis container 100 lie in that a main body 210 of the liquid analysis container 200 further has a third opening 216, and the barrier device 220 covers both the first opening 214 and the third opening 216, and an accommodating cavity 215 is connected to an accommodating space 212 of the main body 210 through the first and the third openings 214 and 216. When a dropper 60 injects an under-testing liquid into the accommodating space 212, the under-testing liquid remaining in the accommodating cavity 215 may flow to the accommodating space 212 through the third opening 216 to undergo subsequent analyses and test together with the under-testing liquid injected into the accommodating space 212.

FIG. 6 is a partial three-dimensional view of a liquid analysis container according to another embodiment of the invention. Please refer to FIG. 6. A liquid analysis container 300 of the present embodiment is similar to the liquid analysis container 200; differences therebetween lie in that an accommodating space 312 of a main body 310 is partitioned into a first subspace 312a and a second space 312b, and the first subspace 312a is connected to an accommodating cavity 315 through a first opening 314. The main body 310 further has a third opening 316. A barrier device 320 covers the third opening 316. The second subspace 312b is connected to the accommodating cavity 315 through the third opening 316. When a dropper 70 injects an under-testing liquid into the first subspace 312a of the accommodating space 312, the under-testing liquid remaining in the accommodating cavity 315 may flow to the second subspace 312b through the third opening 316 to be isolated from the external environment.

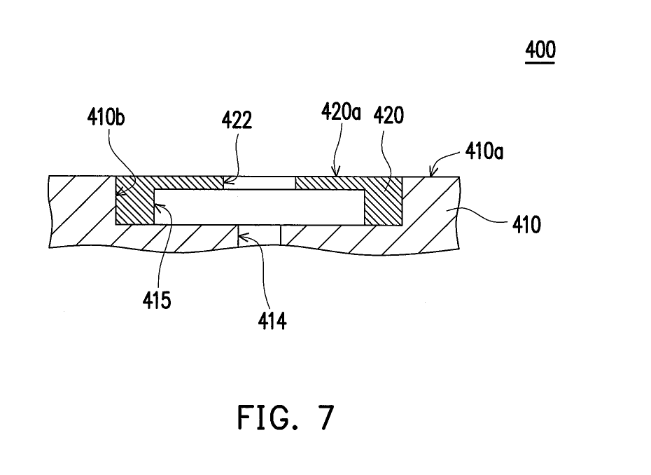

FIG. 7 is a partial cross-sectional view of a liquid analysis container according to another embodiment of the invention. Similar to a disposition way of the liquid analysis container 100 of FIG. 2, in a liquid analysis container 400 shown in FIG. 7, a barrier device 420 covers a first opening 414 of a main body 410, and an opening diameter of a second opening 422 of the barrier device 420 is larger than an opening diameter of the first opening 414 so that the barrier device 420 makes an under-testing liquid which remains around the first opening 414 be limited within an accommodating cavity 415 and makes a dropper unlikely to contact an inner edge of the second opening 422, so as to prevent the under-testing liquid from remaining around the second opening 422. Differences between the liquid analysis container 400 of the present embodiment and the liquid analysis container 100 shown in FIG. 2 lie in that a surface 410a of the main body 410 has a concave 410b, and the first opening 414 is formed at a bottom of the concave 410b, and the barrier device 420 is embedded in the concave 410b.

Based on the above, the barrier device of the invention covers the first opening of the main body, and the opening diameter of the second opening of the barrier device is larger than the opening diameter of the first opening of the main body. When the user uses the dropper to inject the under-testing liquid into the accommodating space through the second and the first openings, the under-testing liquid remaining around the first opening is limited within the accommodating cavity by the barrier device. In addition, the dropper is unlikely to contact the inner edge of the second opening with a larger opening diameter, so that the under-testing liquid does not remain around the second opening. In this way, the under-testing liquid is prevented from remaining on the outside of the liquid analysis container and polluting the analysis equipment, so that the accuracy of liquid analysis is ensured, and the probability that the user becomes infected by contacting the under-testing liquid is lowered.

Though the invention has been disclosed above by the embodiments, they are not intended to limit the invention. It will be apparent to one of ordinary skill in the art that modifications and variations to the invention may be made without departing from the spirit and scope of the invention. Therefore, the protecting range of the invention falls in the appended claims.

What is claimed is:

1. A liquid analysis container, comprising:
a main body including an accommodating space and a first opening; and
a barrier device disposed on the main body and covering the first opening, wherein an accommodating cavity is formed between the barrier device and the main body, the accommodating cavity is connected to the accommodating space through the first opening, the barrier device has a second opening, the accommodating cavity is connected to an external environment through the second opening, and an opening diameter of the second opening is larger than an opening diameter of the first opening.

2. The liquid analysis container of claim 1, wherein a dropper is adapted to be inserted into the accommodating space through the second opening and the first opening and injects an under-testing liquid into the accommodating space, and the under-testing liquid remaining around the first opening is limited within the accommodating cavity by the barrier device.

3. The liquid analysis container of claim 2, wherein when the dropper is inserted into the accommodating space, there is a gap between the dropper and an inner edge of the second opening.

4. The liquid analysis container of claim 1, wherein the first opening is located in an orthographic projection of the second opening on the main body.

5. The liquid analysis container of claim 1, wherein an inner diameter of the accommodating cavity is larger than the opening diameter of the second opening.

6. The liquid analysis container of claim 1, wherein the main body further has a third opening covered by the barrier device, the accommodating cavity is connected to the accommodating space through the third opening, and the under-testing liquid in the accommodating cavity flows to the accommodating space through the third opening.

7. The liquid analysis container of claim 1, wherein the accommodating space is partitioned into a first subspace and a second subspace, the first subspace is connected to the accommodating cavity through the first opening, the main body further has a third opening covered by the barrier device, the second subspace is connected to the accommodating cavity through the third opening, and the under-testing liquid in the accommodating cavity flows to the second subspace through the third opening.

8. The liquid analysis container of claim 1, wherein the main body further has a channel and a chamber, the chamber is connected to the accommodating space through the channel, the chamber is adapted to contain an agent, and the under-testing liquid is adapted to flows to the chamber through the channel.

9. The liquid analysis container of claim 1, wherein the barrier device comprises:
an annular body disposed on the main body and surrounding the first opening; and
a cover covering the annular body, wherein the second opening is formed on the cover, and the accommodating cavity is formed among the cover, the annular body, and the main body.

10. The liquid analysis container of claim 1, wherein a surface of the main body has a concave, and the first opening is formed at a bottom of the concave, and the barrier device is embedded in the concave.
